(19) United States
(12) Patent Application Publication
(10) Pub. No.: US 2014/0063515 A1
(43) Pub. Date: Mar. 6, 2014

(54) NON-TRANSITORY COMPUTER READABLE RECORDING MEDIUM STORING COLOR ADJUSTMENT INSTRUCTING PROGRAM, AND COLOR ADJUSTMENT INSTRUCTING DEVICE

(71) Applicant: KONICA MINOLTA, INC., Tokyo (JP)

(72) Inventor: Tsuyoshi SUGITA, Tokyo (JP)

(73) Assignee: KONICA MINOLTA, INC., Tokyo (JP)

(21) Appl. No.: 14/010,289

(22) Filed: Aug. 26, 2013

(30) Foreign Application Priority Data
Aug. 28, 2012 (JP) 2012-188080

(51) Int. Cl. G06K 15/02

(52) U.S. Cl. CPC G06K 15/1878; G06K 15/027
USPC 358/1.9

(57) ABSTRACT

A color adjustment instructing program of the present invention causes a computer to execute a step (a) of instructing a color chart to be printed, the color chart being formed by a plurality of color patches expressed by different color data, a step (b) of obtaining a color measurement result of a printed material produced by printing in response to the instructing, a step (c) of calculating an adjustment result in a case where adjustment of a conversion table of a color space is performed on the basis of the color measurement result, and a step (d) of displaying the adjustment result calculated for each adjustment and a repeat state of the adjustment, when the adjustment is repeatedly performed.

### CROSS-REFERENCE TO RELATED APPLICATION

This application is based on Japanese Patent Application No. 2012-188080 filed on Aug. 28, 2012, the contents of which are incorporated herein by reference.

### BACKGROUND

1. Technical Field

The present invention relates to a non-transitory computer readable recording medium storing a color adjustment instructing program, and a color adjustment instructing device.

2. Description of Related Art

In a general printing system, printing-target input data is color-converted into output data in a color space that can be printed by a printing engine.

It is known that in such a printing system, color reproducibility is degraded across the ages.

For this reason, in a recent printing system, color conversion from input data into output data can be adjusted such that color reproducibility can be maintained regardless of variation across the ages.

When an operation of this adjustment is manually performed, a user needs to repeatedly perform operation of modifying conversion data (a profile, for example) used in color conversion, and checking an after-printed material with his or her eyes. Accordingly, for a user, operation of color conversion adjustment becomes fairly troublesome.

In order to solve this problem, an image forming apparatus in which operation of color conversion adjustment is automatized has been developed. For example, Japanese Patent Application Laid-Open Publication No. 2004-153667 discloses automatizing an operation of color conversion adjustment, and displaying color reproducibility accuracy before and after the adjustment.

However, in some cases, only displaying color reproducibility accuracy before and after the adjustment is not sufficient for a user who performs adjusting operation. Particularly, when color conversion is adjusted a plurality of times, a problem occurs in that it cannot be recognized what is a main cause for degradation in color reproducibility accuracy. Thereby, adjusting operation cannot be performed efficiently.

### SUMMARY

With view of the above-described problem, objects of the present invention are to provide computer readable recording medium that stores a color adjustment instructing program presenting sufficient information to a user such that operation of color conversion adjustment becomes more efficient, and to provide a color adjustment instructing device.

To achieve at least one of the above-mentioned objects, a non-transitory computer readable recording medium reflecting one aspect of the present invention is a non-transitory computer readable recording medium storing a color adjustment instructing program, the program causing a computer to execute a process including the steps of: (a) instructing a color chart to be printed, the color chart being formed by a plurality of color patches expressed by different color data; (b) obtaining a color measurement result of a printed material that is produced by printing in response to the instructing; (c) calculating an adjustment result in a case where adjustment of a conversion table of a color space is performed on the basis of the color measurement result; and (d) displaying the adjustment result calculated for each adjustment and a repeat state of the adjustment, when the adjustment is repeatedly performed.

Preferably, step (d) includes concurrently displaying, in a predetermined main window, a button for instructing the color chart to be printed, a list of the color measurement results, the adjustment results and the repeat state, a button for causing a transition to a screen image for recalculating the adjustment result, and a button for causing a transition to a screen image for newly calculating an adjustment result.

Preferably, the program causes the computer to further execute the steps of: (e) giving an instruction to start displaying the main window; and (f) selectively registering a part of adjustment results from a plurality of the adjustment results.

Preferably, step (d) includes concurrently displaying, in an initial window different from the main window, an opening button for giving an instruction to start displaying the main window, and a box for instructing the registration.

Preferably, the adjustment result includes information of accuracy concerning conversion of the color space.

Preferably, step (d) includes displaying the accuracy within a predetermined range, by highlighting.

Preferably, step (d) includes displaying a minimum value of the accuracy, by highlighting.

Preferably, step (d) includes displaying contents of processes to be performed in a sub-window, before performing the process of calculating the adjustment result. In addition, it is preferable that, in the sub-window, a button for causing a transition to the initial window, and a button for causing a transition to the main window are provided.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram illustrating a hardware configuration of a printing system.

FIG. 2 is a block diagram illustrating a functional configuration of the printing system.

FIG. 3 is a flowchart illustrating a procedure of a color adjustment instructing process.

FIG. 4 is a flowchart illustrating a procedure of a result calculating process.

FIG. 5 illustrates an example for displaying an initial screen image.

FIG. 6 illustrates an example for displaying a confirmation screen image.

FIG. 7 illustrates an example for displaying a color adjusting wizard screen image.

FIG. 8 illustrates a first example for displaying results and a repeat state of color adjusting operation.

FIG. 9 illustrates a second example for displaying results and a repeat state of color adjusting operation.

### DETAILED DESCRIPTION

The embodiments of this invention will be described below with reference to the accompanying drawings. In the illustration for the drawings, the same reference symbols are attached to the same elements, and the overlapping description will be omitted. Dimension ratios in the drawings are exaggerated for convenience of the illustration, and may be different from the actual dimension ratios.

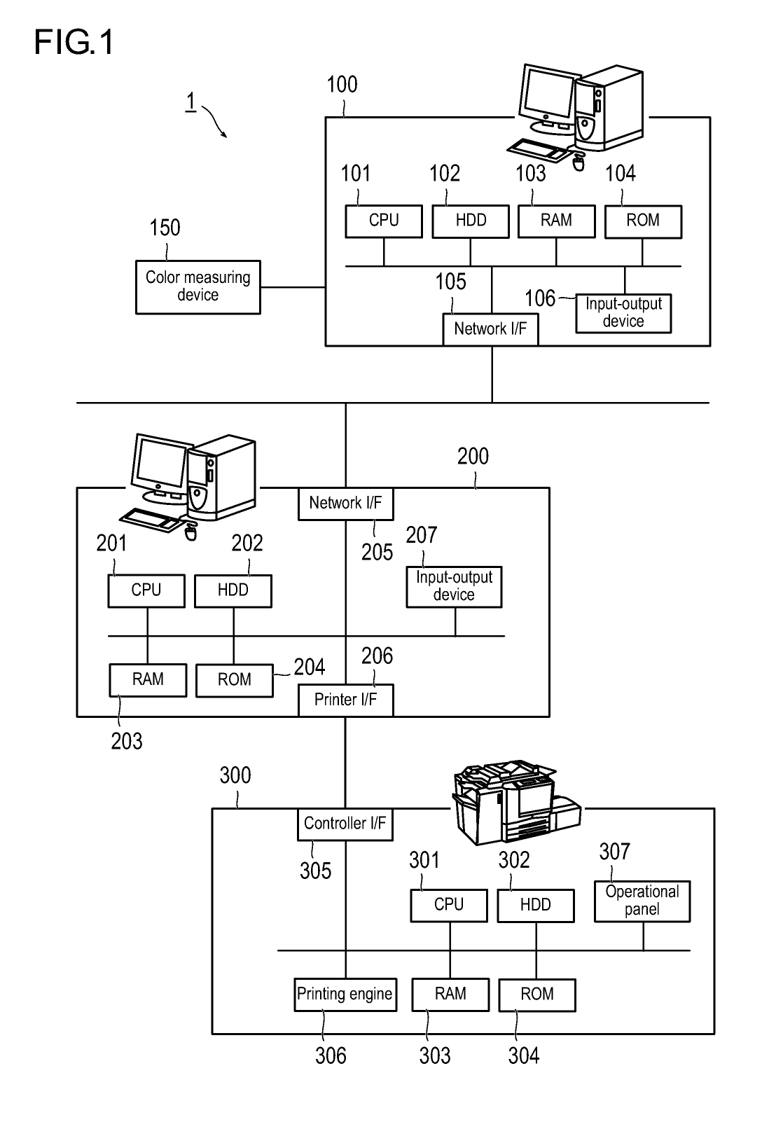

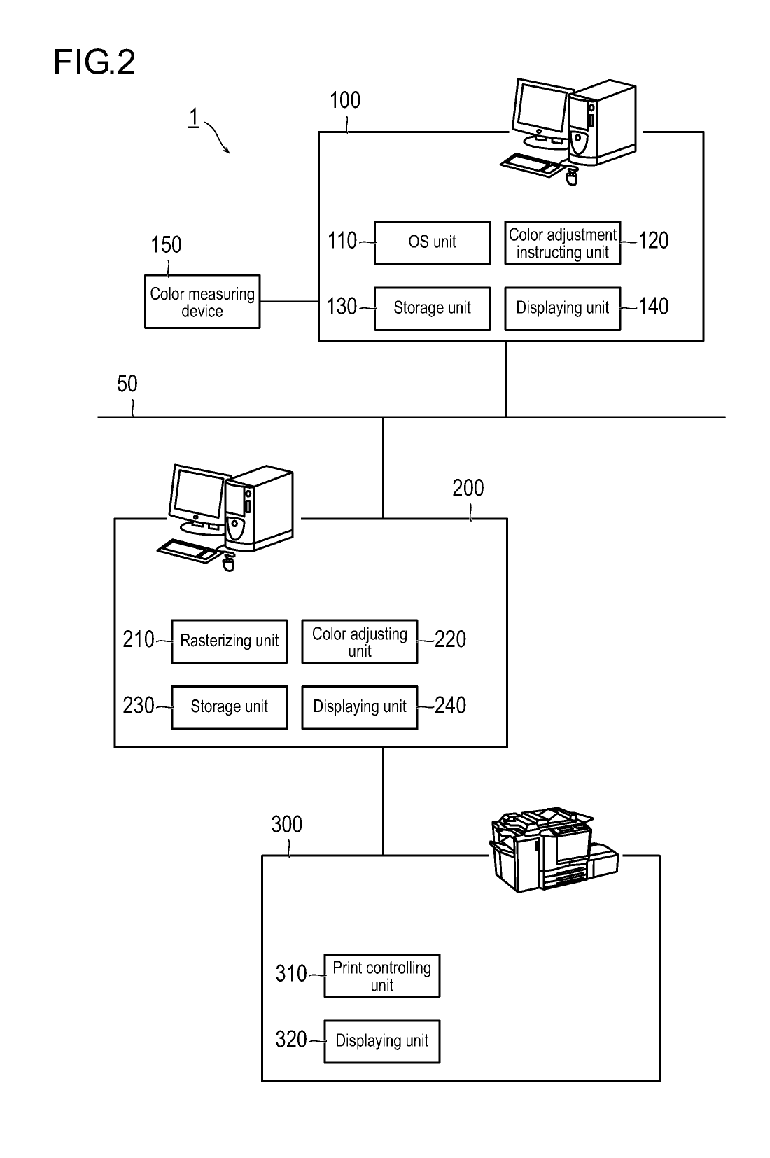

FIG. 1 is a block diagram illustrating one example of a hardware configuration of a printing system 1 according to the present embodiment. FIG. 2 is a block diagram illustrating one example of a basic-function configuration of the printing system 1.

In the following, referring to FIG. 1 and FIG. 2, the schematic configuration of the printing system 1 will be described.

As illustrated in FIG. 1, the printing system 1 includes a client device 100, a printer controller 200, and a printer 300.

The client device 100 and the printer controller 200 are connected to each other via a computer network (simply referred to as “network 50”, in the following) such that the client device 100 and the printer controller 200 can communicate with each other. The network 50 is constituted by a local area network (LAN), a wide area network (WAN), or the like. The LAN is based on the standards such as the Ethernet, the token ring, and the fiber distributed data interface (FDDI), and connects computers and network devices with each other. The WAN is configured by connecting LANs to each other by dedicated lines.

The printer controller 200 and the printer 300 are connected to each other via a dedicated interface bus such as an IEEE1394 serial bus or a universal serial bus (USB). Alternatively, the printer controller 200 and the printer 300 may be connected to each other via the network 50. Further alternatively, the printer controller 200 may be installed in a casing of the printer 300 to integrate the printer controller 200 and the printer 300.

Types and the number of devices connected to the network 50 are not limited to the example illustrated in FIG. 1.

### (Client Device 100)

The client device 100 is a general computer device for instructing, by remote operation, adjustment for a rasterizing process performed by a RIP (Raster Image Processor) of the printer controller 200. Particularly, the client device 100 is for instructing a color converting process of converting a color space of printing target data.

Generally, adjusting operation for the color converting process (also referred to as “color adjusting operation”) includes the following steps which are repeatedly performed.

(i) A color conversion table determining relation between input and output in the color converting process is adjusted (modified).
(ii) A color chart, formed by a plurality of color patches each of which is expressed by different color data, is color-converted using the adjusted (modified) color conversion table to be printed.
(iii) Colors of the printed result (printed material) of the color chart are measured by a color measuring device 150.
(iv) The measured colors are compared with color values that are standards of the color chart to calculate a result of the adjustment performed at step (i).

The operation of the above-described step (i) is also referred to as “calibration” in the following.

Used as the client device 100 that functions as an instructing terminal of the above-described color adjusting operation is a personal computer (PC), or a portable terminal such as a tablet PC, a smart phone, a cellular phone, or a PDA.

As illustrated in FIG. 1, the client device 100 includes a central processing unit (CPU) 101, a hard disk (HDD) 102, a random access memory (RAM) 103, a read only memory (ROM) 104, a network interface 105, and an input-output device 106. These elements are connected to each other via a bus for exchanging signals.

The CPU 101 is a control circuit constituted by a multi-core processor or the like that, according to programs, controls each of the above-described elements, and performs various types of arithmetic processes. Each function of the client device 100 is activated by the CPU 101 executing the corresponding program.

The hard disk 102 is a high-capacity non-volatile storage device that stores various types of programs including various applications, a printer driver, an operating system (OS), and stores various types of data. For example, installed in the hard disk 102 are the application for creating printing target data (document file or the like), and the printer driver for converting the printing target data into page description language (PDL) data described by the PDL that can be interpreted by the printer controller 200. Further, installed in the hard disk 102 is the application for instructing adjustment concerning the rasterizing process (particularly a color converting process among a language analyzing process, the color converting process, a screen process and the like) performed by the printer controller 200. Instead of the hard disk 102, a storage device using a semiconductor memory such as a solid state drive (SSD) or a compact flash (registered trade mark) can be adopted to appropriately store the above-described various types of the programs, and the above-described various types of the data.

The RAM 103 is a high-speed volatile storage device that functions as a work area to temporarily store programs and data.

The ROM 104 is a low-capacity non-volatile memory that stores various types of programs and various types of data.

The network interface 105 is an interface for communicating with another device (the printer controller 200, for example) via the network 50. The network interface 105 is based on a standard such as the Ethernet, the token ring, or the FDDI.

The input-output device 106 includes an input device such as a keyboard and a mouse, and an output device such as a liquid crystal display, for example.

Connected to the client device 100 is the color measuring device 150, as illustrated in FIG. 1. The color measuring device 150 measures colors of a printed result (printed material) of a color chart to provide the client device 100 with the color measurement result. The color measuring device 150 and the client devices 100 are connected to each other via general connection interfaces not illustrated in the drawing.

The client device 100 having the above-described hardware configuration includes, as a functional configuration, an operating system (OS) unit 110, a color adjustment instructing unit 120, a storage unit 130, and a displaying unit 140 as illustrated in FIG. 2.

For example, the OS unit 110 is what is called operating system for a computer that provides a system management and a basic user interface.

The color adjustment instructing unit 120 generates a graphical user interface (GUI) for instructing adjustment concerning the rasterizing process (particularly, the color converting process) performed by the printer controller 200. As described above, the color converting process is a process of color-converting printing target data into output data in a color space (CMYK, for example) that can be printed by the printer 300. The color adjustment instructing unit 120 gives an instruction to the printer controller 200 about the adjustment contents input by using the GUI.

The storage unit 130 stores the color values that are standards for each color patch which forms a color chart, a color measurement result of a color chart obtained from the color measuring device 150, and an adjustment result concerning the color converting process that has been performed by the printer controller 200, and so on.

The displaying unit 140 displays the GUI provided by the color adjustment instruction unit 120.

The CPU 101 reads out, to the RAM 103, the OS and the program installed in the hard disk 102 to execute the read OS and programs. Thereby, the OS unit 110 and the color adjustment instruction unit 120 are embodied. The storage unit 130 is embodied by the hard disk 102 and the ROM 104. The displaying unit 140 is embodied by an output device such as a display.

### (Printer Controller 200)

The printer controller 200 is a data generating device used for converting PDL data forwarded from the client device 100 into raster data (image data), and forwarding the raster data to the printer 300.

As illustrated in FIG. 1, the printer controller 200 includes a CPU 201, a hard disk 202, a RAM 203, a ROM 204, a network interface 205, a printer interface 206, and an input-output device 207. These elements are connected to each other via a bus for exchanging signals.

The CPU 201 is a control circuit constituted by a multi-core processor or the like that, according to programs, controls each of the above-described elements, and performs various types of arithmetic processes. Each function of the printer controller 200 is activated by the CPU 201 executing the corresponding program.

The hard disk 202 is a high-capacity non-volatile storage device that stores various types of programs for controlling the printer controller 200, and stores various types of data. The programs installed in the hard disk 202 include the program for performing the rasterizing process on PDL data forwarded from the client device 100, the program for performing the color adjusting operation, and so on.

The RAM 203 is a high-speed volatile storage device that functions as a work area to temporarily store programs and data.

The ROM 204 is a low-capacity non-volatile memory that stores various types of programs and various types of data.

The network interface 205 is an interface for communicating with another device (the client device 100, for example) via the network 50. The network interface 205 is based on a standard such as the Ethernet, the token ring, or the FDDI.

The printer interface 206 is a dedicated interface (video interface: VIF) for communicating with the printer 300. The printer interface 206 successively forwards, to the printer 300, raster data that has been subjected to the rasterizing process. Instead of the VIF, any of other interfaces can be appropriately adopted, the interfaces including serial interfaces such as the recommended standard 232 (RS-232) version C, the Institute of Electrical and Electronics Engineers (IEEE) 1394, and a universal serial bus (USB), a parallel interface such as the IEEE 1284, and a unique standard interface.

The input-output device 207 includes an input device such as a keyboard and a mouse, and includes an output device such as a liquid crystal display, for example.

The printer controller 200 having the above-described hardware configuration includes, as a functional configuration, an rasterizing unit 210, a color adjusting unit 220, a storage unit 230, and a displaying unit 240, as illustrated in FIG. 2.

The rasterizing unit 210 performs the rasterizing process on PDL data received from the client terminal 100, to generate raster data (image data) in a bitmap format. As described above, the rasterizing process performed by the rasterizing unit 210 includes the language analyzing process, the color converting process, the screen process and the like.

The language analyzing process is a process of analyzing PDL data to convert the PDL data into intermediate data called Display List. The intermediate data is stored in the RAM 203 or the like. The intermediate data may be generated for each object, or may be generated in band unit.

The color converting process is a process for converting a color space of the intermediate data (printing target data) generated by the language analyzing process, into a color space for output.

Colors of the intermediate data is specified by the color space based on RGB (red, green, and blue), gray scale, CMYK (cyan, magenta, yellow, and key), CIE (Commission Internationale de l'Eclairage), or the like. The color space supported by a printing engine 306 provided in the printer 300 is the color space based on CMYK. Accordingly, in the present embodiment, the intermediate data is converted from the input color space into the color space based on CMYK, in the color converting process.

For example, in the color converting process, a color conversion table called a look-up table (LUT) is used. For example, a method using the international color consortium (ICC) profile may be applied. Alternatively, in PostScript language, a method using the color space array (CSA) or the color rendering dictionary (CRD) may be applied.

The screen process is a process of binarizing the color-converted intermediate data. By the screen process, raster data of one page is generated to be extracted to a frame memory of the RAM 203, or the like.

The color adjusting unit 220 performs calibration according to a user instruction. For example, the color adjusting unit 220 performs the process concerning the above-described step (i), i.e., the process of adjusting (modifying) the color conversion table. Further, the color adjusting unit 220 performs the process concerning the above-described step (ii), i.e., the process of using the adjusted color conversion table to color-convert a color chart, and outputting the color-converted color chart to the printer 300.

The storage unit 230 stores the color conversion table used for the color converting process, and an adjustment result of the color conversion table, and so on.

The displaying unit 240 displays a screen image necessary for operation in the printer controller 200. The displaying unit 240 may display the same screen image as a screen image displayed by the displaying unit 140 of the client device 100.

The CPU 201 reads out corresponding program installed in the hard disk 202 to the RAM 203 and executes the read-out program, thereby the rasterizing unit 210 and the color adjusting unit 220 are embodied. It is not limited to this manner, the rasterizing unit 210 and the color adjusting unit 220 may be embodied by hardware such as application specific integrated circuit (ASIC). The storage unit 230 is embodied by the hard disk 202 and the ROM 204. The displaying unit 240 is embodied by an output device such as a display.

### (Printer 300)

The printer 300 has at least a printer function. The printer 300 is used to print raster data forwarded from the printer controller 200. The printer 300 may be a multi-function peripheral (MFP) having not only the printer function, but also a copy function, a scan function, a facsimile function, and/or the like.

The printer 300 includes a CPU 301, a hard disk 302, a RAM 303, a ROM 304, a controller interface 305, the printing engine 306, and an operational panel 307, as illustrated in FIG. 1. These elements are connected to each other via a bus for exchanging signals.

The CPU 301 is a control circuit constituted by a microprocessor or the like that, according to programs, controls each of the above-described elements, and performs various types of arithmetic processes. Each function of the printer 300 is activated by the CPU 301 executing the corresponding program.

The hard disk 302 is a high-capacity non-volatile storage device that stores various types of programs for controlling the printer 300, and various types of data.

The RAM 303 is a high-speed volatile storage device that functions as a work area to temporarily store the programs and data.

The ROM 304 is a low-capacity non-volatile memory that stores various types of programs and various types of data.

The controller interface 305 is a dedicated interface (video interface: VIF) for communicating with the printer controller 200. Instead of the VIF, any of other interfaces can be appropriately adopted, the interfaces including serial interfaces such as the recommended standard 232 (RS-232) version C, the Institute of Electrical and Electronics Engineers (IEEE) 1394, and a universal serial bus (USB), a parallel interface such as the IEEE 1284, and a unique standard interface.

The printing engine 306 prints raster data output from the printer controller 200. For example, the printing engine 306 is a laser type unit that includes a cartridge into which toner has been filled, a photo conductor drum, a laser light emitting mechanism, a paper transfer mechanism, a paper feed-and-discharge mechanism, and the like, and that transfers toner to a print medium such as print paper sheet to perform printing. The printing engine 306 may be other types such as an inkjet type.

The operational panel 307 includes a touch panel, and is configured to display a state of progress of a printing job and an error occurrence state and to enable various types of operation (input).

The printer 300 including the above-described hardware configuration includes, as a functional configuration, a print controlling unit 310, and a displaying unit 320, as illustrated in FIG. 2.

The print controlling unit 310 prints raster data output from the printer controller 200. Specifically, in accordance with a print command received with the raster data, the print controlling unit 310 controls the printing engine 306 and a print head (not illustrated in the drawings) to perform a printing process.

The displaying unit 320 displays a state of progress of a printing job, and an error occurrence state.

The CPU 301 reads out the program installed in the hard disk 302 to the RAM 303, to execute the read-out program. In this manner, the print controlling unit 310 is embodied. It is not limited to this manner, the print controlling unit 310 may be embodied by hardware such as application specific integrated circuit (ASIC). The displaying unit 320 is embodied by an operational panel 307 such as a touch panel.

The client device 100, the printer controller 200, and the printer 300 may include constituent elements other than the above-described constituent elements, or may exclude a part of the above-described constituent elements.

The printer controller 200 and the printer 300 may be connected to each other via the network 50.

Next, operation of the printing system 1 will be described.

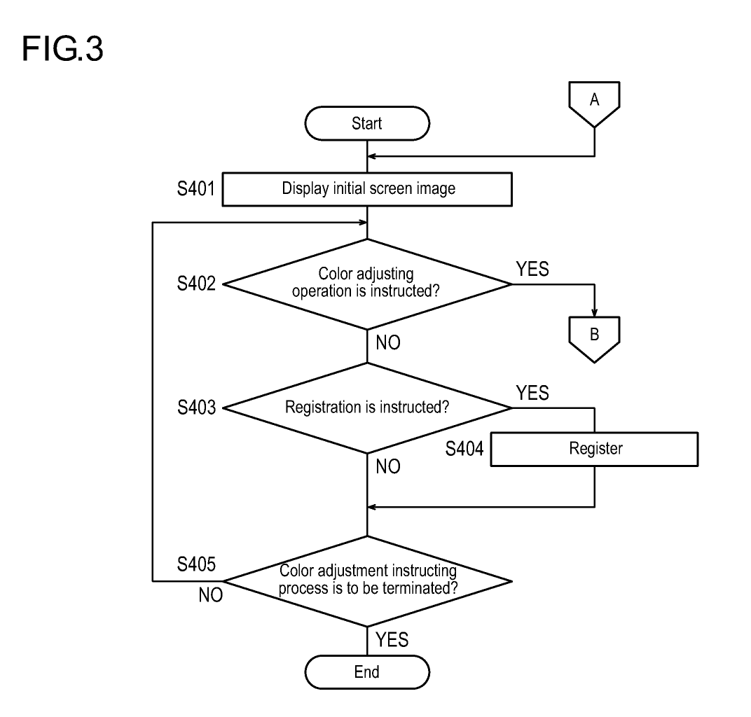

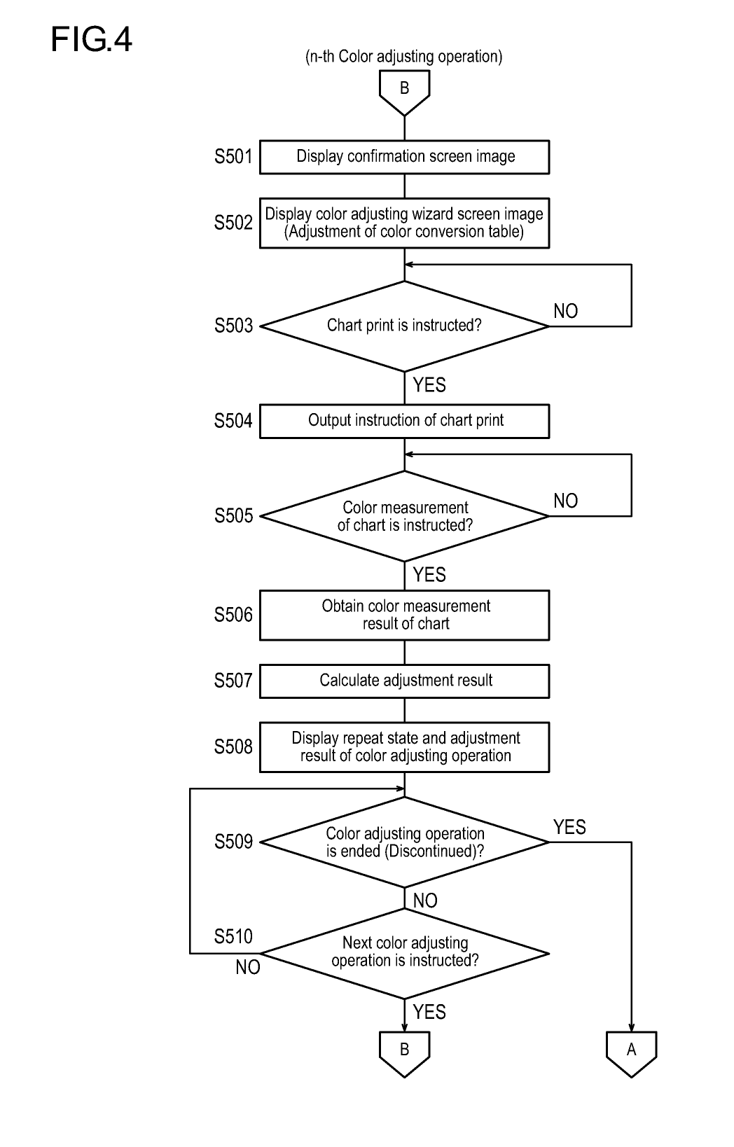

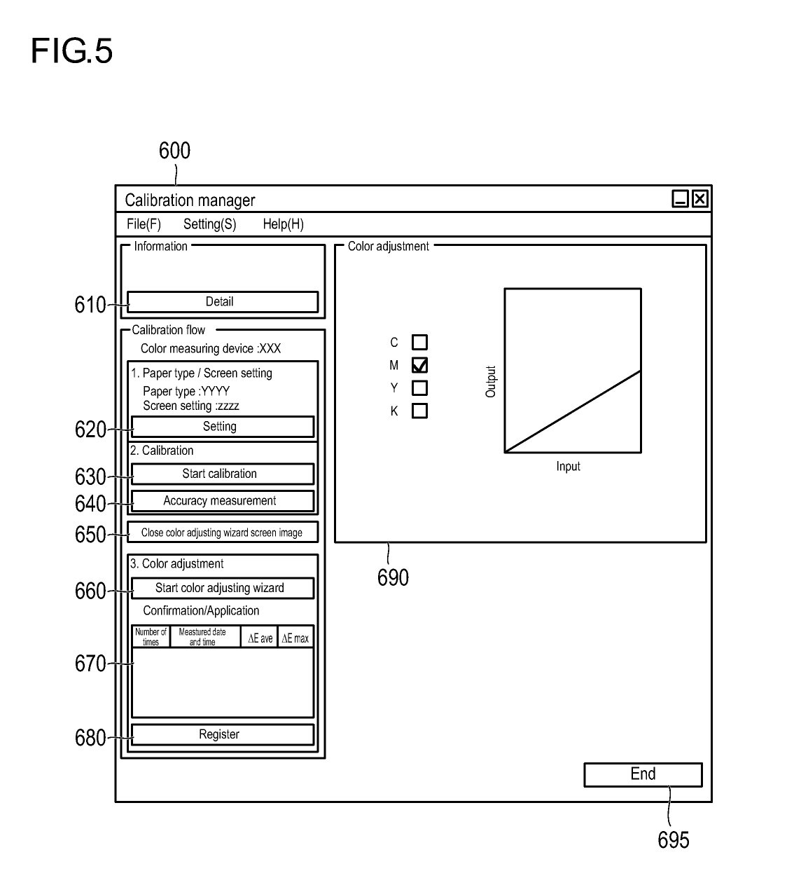

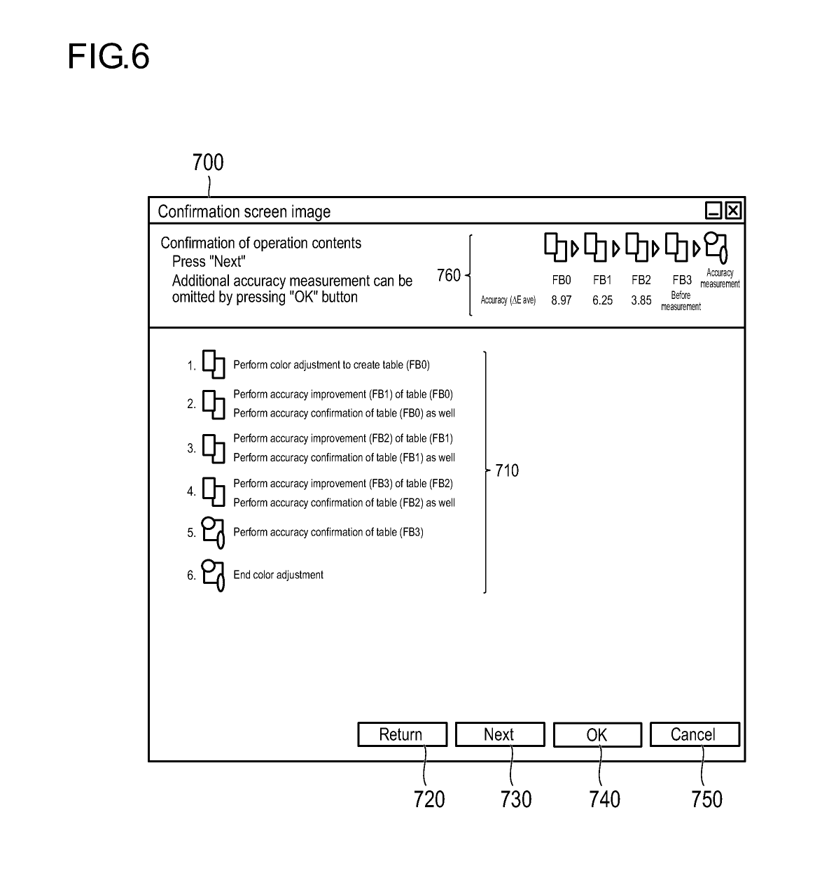

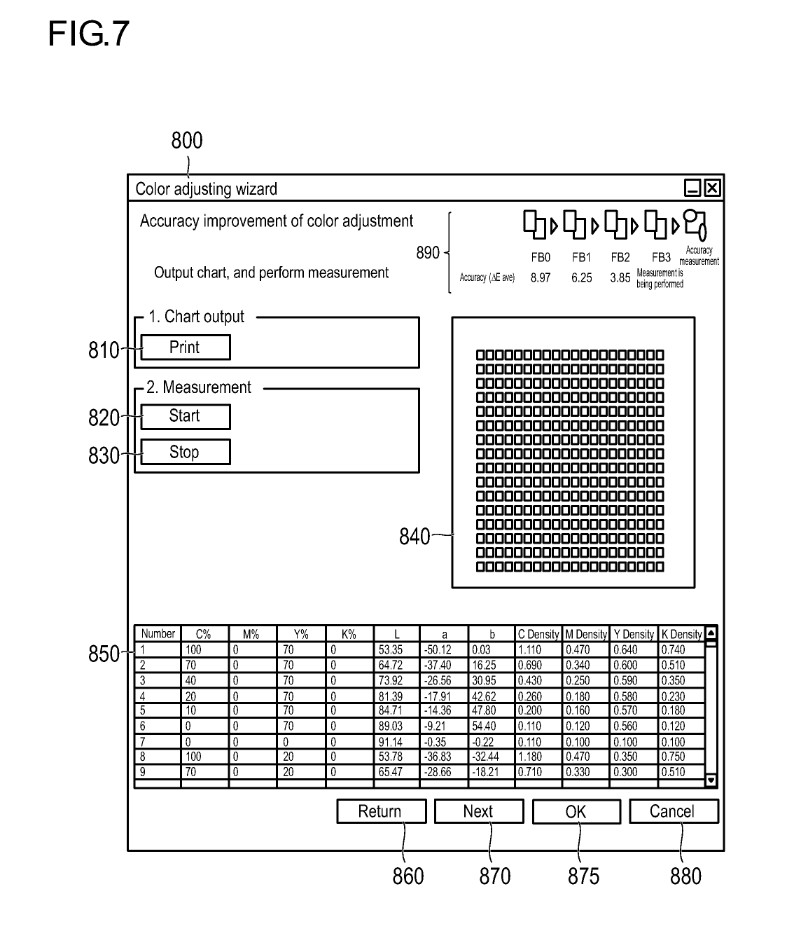

FIG. 3 is a flowchart illustrating a procedure of a process (referred to as “color adjustment instructing process” in the following) of instructing, from the side of the client device 100, an adjustment concerning the color converting process performed by the printer controller 200. FIG. 4 is a flowchart illustrating a procedure of a process (referred to as “result calculating process” in the following) of calculating an adjustment result of the color conversion table used for the color converting process. FIG. 5, FIG. 6, and FIG. 7 respectively illustrate examples of an initial screen image (initial window) 600, a confirmation screen image (sub-window) 700, and a color adjusting wizard screen image (main window) 800, that are displayed in accordance with the color adjustment instructing process or the result calculating process.

### <Color Adjustment Instructing Process (FIG. 3) and Result Calculating Process (FIG. 4)>

The client device 100 starts the color adjustment instructing process illustrated in FIG. 3 at the timing that a predetermined icon for starting the color adjustment instructing process is operated, for example.

When the present flowchart is started, the client device 100 displays the initial screen image 600 of the color adjustment instructing process to enable color adjusting operation to be performed (step S401). Specifically, the client device 100 functions as the color adjustment instructing unit 120 to display the initial screen image 600, as illustrated in FIG. 5, on an output device such as a display.

For example, provided in the initial screen image 600 are a detail button 610 for causing detailed information such as a date of the latest calibration to be displayed, a setting button 620 for performing setting on calibration, a calibration button 630 for performing calibration, a result button 640 for calculating a result of calibration, a closing button 650 for closing the color adjusting wizard screen image 800, an opening button 660 for opening the color adjusting wizard screen image 800, a result list region (box) 670 for displaying a list of results for respective calibration, a registering button 680 for registering contents of the color conversion table that produces a selected calibration result, an adjusting region 690 for adjusting contents of the color conversion table, and an end button 695 for ending the color adjustment instructing process.

After the initial screen image 600 is displayed, the client device 100 determines whether or not a start of color adjusting operation is instructed (step S402). Specifically, the client device 100 functions as the color adjustment instructing unit 120 to determine whether or not the opening button 660 in the initial screen image 600 is operated. When the opening button 660 is operated (yes at step S402), the client device 100 determines that a start of color adjusting operation is instructed, and the procedure proceeds to the result calculating process illustrated in FIG. 4.

When the result calculating process is started, the client device 100 displays the confirmation screen image 700 about procedure (contents) of the color adjusting operation to be performed now with a user, before performing the process of calculating the adjustment result, as illustrated in FIG. 4 (step S501). Specifically, the client device 100 functions as the color adjustment instructing unit 120 to display, at the output device such as a display, the confirmation screen image 700 as illustrated in FIG. 6.

For example, provided in the confirmation screen image 700 are a content confirmation region 710 that displays contents or the like of the color adjusting operation to be performed now and the already-performed color adjusting operation, a return button 720 for switching to a display at the time of the last ((n−1)th) color adjusting operation, a next button 730 for switching to a display at the time of next ((n+1)th) color adjusting operation, an OK button 740 for informing the computer that a user has confirmed contents displayed on the confirmation screen image 700, a cancel button 750 for closing the confirmation screen image 700 to cause a transition to the initial screen image 600, and a result region 760 that displays an adjustment result of the color conversion table (i.e., a result of calibration), and that displays a repeat state of the color adjusting operation (the result calculating process illustrated in FIG. 4).

When the OK button 740 in the confirmation screen image 700 is operated, the client device 100 closes the confirmation screen image 700, and newly causes a transition to the color adjusting wizard screen image 800 (step S502). Specifically, the client device 100 functions as the color adjustment instructing unit 120 to display the color adjusting wizard screen image 800 as illustrated in FIG. 7 on the output device such as a display.

For example, provided in the color adjusting wizard screen image 800 are a print button 810 for instructing print of a color chart, a color measurement starting button 820 for causing the color measuring device 150 to measure colors of the printed result of the color chart (printed material), a color measurement stopping button 830 for the color measuring device 150 to stop color measurement, a chart displaying region 840 displaying the color chart, a color value displaying region 850 displaying color values (CMYK values) which are the standards for each color patch which forms the color chart and displaying a list of the color measurement results by the color measuring device 150, a return button 860 for switching to a display at the time of the last ((n−1)th) color adjusting operation, a next button 870 for switching to display at the time of next ((n+1)th) color adjusting operation, an OK button 875 for ending the color adjusting operation, a cancel button 880 for discontinuing the color adjusting operation, and a result region 890 displaying an adjustment result of the color conversion table (i.e., a result of calibration) and displaying a repeat state of the color adjusting operation (the result calculating process).

In the color value displaying region 850, the identification number, CMYK values (%) that are used as standards, color values (Lab values) measured by the color measuring device 150, and values (CMYK values) in the CMYK space converted from the measured color values are displayed in the color value displaying region 850 for each color patch which forms the color chart, so as to be related to each other. The result region 890 displayed in the color adjusting wizard screen image 800 may be the same as the result region 760 displayed in the confirmation screen image 700.

The color adjusting wizard screen image 800 is displayed to generate a state where both windows of the initial screen image 600 and the color adjusting wizard screen image 800 are displayed on the output device such as a display of the client device 100.

At this time, a user can perform operation for rewriting numerical values displayed in the adjusting region 690 of the initial screen image 600, or other operation to make instruction for adjusting (modifying) the color conversion table. For example, a user can make instruction for the color conversion table such that red becomes bright.

Operating the calibration button 630 causes the instruction for adjusting (modifying) the color conversion table to be given from the client device 100 to the printer controller 200. At this time, the printer controller 200 functions as the color adjusting unit 220 to adjust (modify) the color conversion table in accordance with the instruction given from the client device 100. Thereby, the adjusted (modified) color conversion table is used for the subsequent color converting processes.

After the above-described calibration is performed, the client device 100 determines whether or not a user instructs printing of the color chart (step S503). Specifically, the client device 100 functions as the color adjustment instructing unit 120 to detect whether or not the print button 810 in the color adjusting wizard screen image 800 is operated.

When the print button 810 in the color adjusting wizard screen image 800 is not operated (no at step S503), the client device 100 determines that printing of the color chart is not instructed, and waits until the print button 810 is operated.

When the print button 810 is operated (yes at step S503), the client device 100 determines that printing of the color chart is instructed, and outputs an instruction of printing the color chart to the printer controller 200 (step S504). Specifically, the client device 100 reads out the color chart stored in the storage unit 130 in advance, to transmit the read-out color chart to the printer controller 200, with the printing command. At this time, the printer controller 200 receives the color chart, and thereby functions as the rasterizing unit 210 to convert the received color chart into data (CMYK data) in a data format that can be printed by the printer 300. Then, the printer controller 200 transmits the CMYK data to the printer 300 to cause the printer 300 to print the CMYK data. In this manner, the printed result (printed material) of the color chart is obtained by the printer 300.

Next, the client device 100 determines whether or not a user has instructed color measurement of the color chart (step S505). Specifically, the client device 100 functions as the color adjustment instructing unit 120 to detect whether or not the color measurement starting button 820 in the color adjusting wizard screen image 800 has been operated.

If there is no operation of the color measurement starting button 820 in the color adjusting wizard screen image 800 (no at step S505), the client device 100 determines that color measurement of the color chart has not been instructed. Accordingly, the client device 100 waits until the color measurement starting button 820 is operated.

If there is operation of the color measurement starting button 820 (yes at step S505), the client device 100 determines that color measurement of the color chart has been instructed. Accordingly, the client device 100 urges a user to measure colors of the color chart (step S506). Specifically, the client device 100 displays a predetermined message on the output device such as a display. At this time, a user uses the color measuring device 150 to perform color measurement on the printed result of the color chart output from the printer 300 at step S504. Then, the result of the color measurement is given from the color measuring device 150 to the client device 100 via a predetermined cable. In this manner, the client device 100 can obtain the measured color values (Lab values) for each of the color patches which form the color chart. The thus-obtained measured color values (Lab values) are converted into the CMYK values by the client device 100. Then, the converted CMYK values are displayed in the color value displaying region 850 of the color adjusting wizard screen image 800.

Next, the client device 100 calculates an adjustment result of the color conversion table (step S507) in order to make evaluation on adjustment (modification) of the color conversion table performed at step S502. Specifically, the client device 100 functions as the color adjustment instructing unit 120 to compare the measured color values of the color chart with the color values that are standards for the color chart. Thereby, the client device 100 calculates the adjustment result of the color conversion table.

In the present embodiment, average measurement accuracy (error) concerning conversion of the color space is obtained as one example of the adjustment result by the following equation 1 and equation 2;

4Eab={(L1−L2)²+(a1−a2)²+(b1−b2)²}^{1/2)} (equation 1)

ΔEave=Σ(ΔEab)/N (equation 2)

where the symbol “LEab” represents measurement accuracy of each color patch, the symbols “L1”, “a1”, and “b1” represent the color values (Lab values) that are standards for the color chart, and the symbols “L2”, “a2”, and “b2” represent the measured color values (Lab values) of the color chart. The respective color values “L1”, “a1”, and “b1” are stored in the storage unit 230 in advance. The respective color values “L2”, “a2”, and “b2” are the measured color values obtained at step S506. The symbol “ΔEave” represents an average value (average measurement accuracy) for ΔEab of all color patches which form the color chart. The symbol “N” represents the number of all the color patches which form the color chart.

The client device 100 may obtain the maximum measurement accuracy ΔEmax that is the maximum value among measurement accuracy ΔEab of the respective color patches.

Subsequently, the client device 100 displays, in the result region 890 of the color adjusting wizard screen image 800, the adjustment result of the color conversion table and a repeat state of the color adjusting operation, i.e., the result calculating process (step S508). Specifically, the client device 100 functions as the color adjustment instructing unit 120 to display identification information such as a character and a symbol that can identify the number “n” of times the color adjusting operation being performed, and to display the adjustment result (average measurement accuracy ΔEave, for example) calculated at step S507, such that the identification information and the adjustment result are displayed side by side.

In order to identify the number of times the color adjusting operation being performed, character strings such as strings FB0, FB1, FB2, FB3 or icons of printed objects or the like for the respective color adjusting operation may be displayed Fig. as illustrated in FIG. 7, for example.

Next, the client device 100 determines whether or not ending or discontinuing all the color adjusting operation is instructed (step S509). Specifically, the client device 100 functions as the color adjustment instructing unit 120 to detect whether or not the OK button 875 or the cancel button 880 in the color adjusting wizard screen image 800 is operated.

When there is no operation of the OK button 875 or the cancel button 880 in the color adjusting wizard screen image 800 (no at step S509), the client device 100 determines that ending or discontinuing all the color adjusting operation is not instructed. Accordingly, the client device 100 advances the process to step S510.

Then, the client device 100 determines whether or not starting the next ((n+1)th) color adjusting operation has been instructed (step S510). Specifically, the client device 100 functions as the color adjustment instructing unit 120 to detect whether or not the next button 870 in the color adjusting wizard screen image 800 is operated.

When there is no operation of the next button 870 in the color adjusting wizard screen image 800 (no at step S510), the client device 100 waits until any one of the next button 870, the OK button 875, and the cancel button 880 in the color adjusting wizard screen image 800 is operated.

When there is operation of the next button 870 in the color adjusting wizard screen image 800 (yes at step S510), the client device 100 returns the process to step S501, and starts the next ((n+1)th) color adjusting operation. At the time of the next color adjusting operation, the contents displayed in the confirmation screen image 700, and the contents displayed in the color value displaying region 850 and the result region 890 in the color adjusting wizard screen image 800 are updated.

Meanwhile, when there is operation of the OK button 875 or the cancel button 880 in the color adjusting wizard screen image 800 at step S509 (yes at step S509), the client device 100 closes the color adjusting wizard screen image 800, and returns the process to the step S401 as illustrated in FIG. 3.

When the process returns from the step S509 to the step S401, the client device 100 reflects, in the result list region 670 of the initial screen image 600, the result of the calibration performed during the current (n-th) color adjusting operation. For example, the client device 100 displays, in the result list region 670, the number “n” of times the color adjusting operation is performed, the date and time of the calibration, and the average measurement accuracy ΔEave and the maximum measurement accuracy ΔEmax calculated at step S507 so as to be related to each other in the result list region 670.

The color adjusting operation is repeatedly performed so that the results of the respective performed calibration (color adjusting operation) are displayed as a list in the result list region 670 of the initial screen image 600. At this time, a user can select the calibration that leads to the best adjustment result (for example, the minimum of the values “ΔEave”), and registers the color conversion table generated by the selected calibration.

For example, when the opening button 660 in the initial screen image 600 is not operated at step S402 (no at step S402), and the registering button 680 is operated (yes at step S403), the client device 100 registers, in the storage unit 130, the color conversion table generated by the calibration that is selected in the result list region 670 (step S404). In this manner, a user can efficiently specify the color adjusting operation that produces the best adjustment result, among the plural times of the performed color adjusting operation, and can easily register, with the printer controller 200, the color conversion table used in the corresponding color adjusting operation.

After the color conversion table is registered, or when the registering button 680 is not operated (no at step S403), the client device 100 determines whether or not terminating the color adjustment instructing process is instructed (step S405). Specifically, the client device 100 detects whether or not the end button 695 in the initial screen image 600 is operated.

When the end button 695 is not operated (no at step S405), the client device 100 waits until any one of the opening button 660, the registering button 680, and the end button 695 in the initial screen image 600 is operated.

Meanwhile, when the end button 695 is operated (yes at step S405), the client device 100 closes the initial screen image 600 to terminate the color adjustment instructing process.

The n-th (current) color adjusting operation is performed on the basis of the (n−1)th (last) color adjusting operation, which is not illustrated in detail in the above-mentioned flowchart. In other words, calibration performed during the n-th color adjusting operation is performed by modifying the color conversion table (profile or the like) generated by the calibration that is performed during the (n−1)th color adjusting operation. For this reason, normally, on the assumption that the color adjusting operation is appropriately performed, the result (accuracy) of the calibration is improved each time the color adjusting operation is repeatedly performed.

However, a user cannot always perform an appropriate calibration. Further, while the color adjusting operation is repeated, an environment (temperature, humidity or the like) in which the color chart is printed is not always stable. Colors of the color chart are measured manually by using the color measuring device 150, so that an error can occur among respective color measurement. These can cause a result of the n-th (current) color adjusting operation to be worse than a result of the (n−1)th (last) color adjusting operation.

In such a case, the result, the contents of the color conversion table, and the like of the n-th (current) color adjusting operation are unnecessary. For this reason, the return buttons 720 and 860 are provided in the confirmation screen image 700 and the color adjusting wizard screen image 800, respectively, and operating the return button 720 or 860 enables the n-th color adjusting operation to be performed again. Even when the return button 720 or 860 is operated, if a user changes his or her mind and operates the next button 730 or 870, the result and the like of the n-th color adjusting operation is displayed again so that the (n+1)th color adjusting operation can be then performed.

The above-described color adjustment instructing process and result calculating process are performed by the client device 100 so that the adjusting result of the color conversion table is displayed each time the color adjusting operation is performed. Further, the repeat state of the color adjusting operation is also displayed. Accordingly, a user can easily recognize effectiveness of the respective color adjusting operation by seeing the adjustment results displayed for the respective color adjusting operation. A user can efficiently select the optimum adjustment result from a plurality of the displayed adjustment results, and register the contents of the color conversion table generated at that time. Further, a user can see the repeat state of the color adjusting operation to recognize adjustment progress state such as the performed order number of the currently performed color adjusting operation. A user can comprehensively see the displayed adjustment results and repeat state to appropriately determine whether or not the additional color adjusting operation should be performed, and to appropriately determine how to adjust (modify) the color conversion table when the additional color adjusting operation is performed.

Each of the process units in each of the above-mentioned flowcharts is a unit divided in accordance with main process contents, to facilitate understanding of the printing system 1. A manner of classifying the process steps and the names of the process steps do not limit the present invention. The process performed by the printing system 1 can be divided into more steps. One process step may perform more process contents.

The above-described embodiments are intended for exemplifying the gist of the present invention, and do not limit the present invention. Many alternatives, modified examples, and altered examples are apparent for a person skilled in the art.

For example, in the above-described embodiments, the number of times that the color adjusting operation is performed, and the adjustment results (average measurement accuracy ΔEave, in the illustrated example) are displayed side by side in the result region 890 in the color adjusting wizard screen image 800. However, it is not limited to this manner, and a different manner of displaying the results and the repeat state of the color adjusting operation may be adopted.

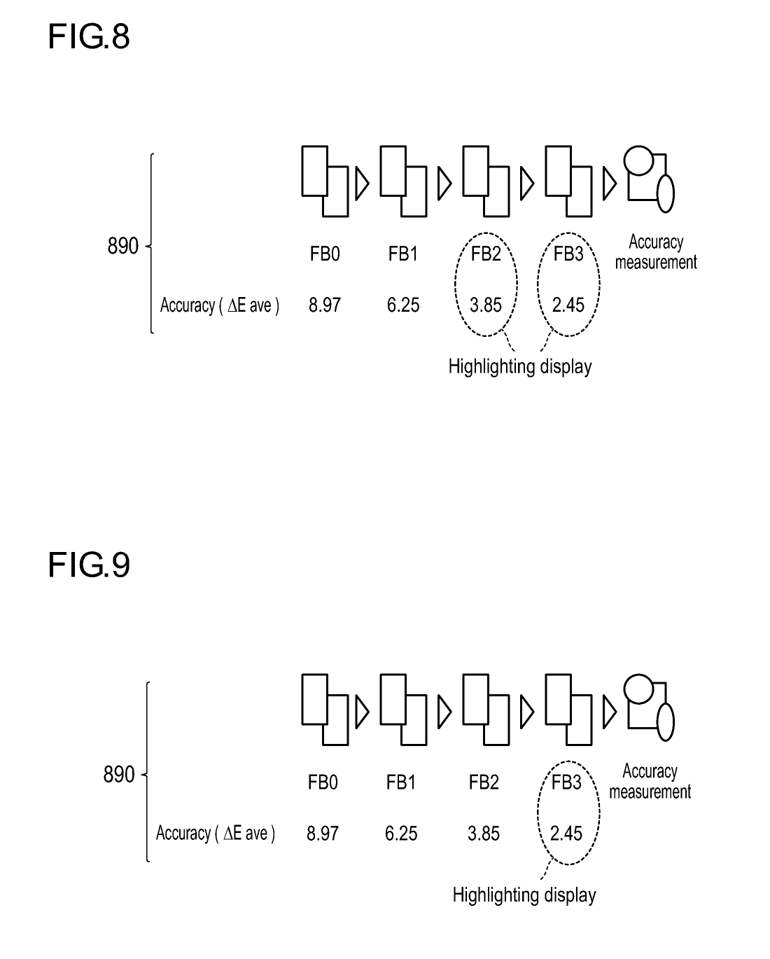

FIG. 8 illustrates a first example for displaying the results and the repeat state of the color adjusting operation. As illustrated in FIG. 8, for example, the adjustment results of which average measurement accuracy ΔEave is within a predetermined range, for example smaller than a predetermined threshold (four, for example) may be displayed by highlighting such that a user can instantly notice the performed order number of the color adjusting operation that is appropriate. In addition to the adjustment results, a character string or an icon representing the repeat state may be displayed by highlighting.

FIG. 9 illustrates a second example for displaying the results and the repeat state of the color adjusting operation. As illustrated in FIG. 9, for example, the adjustment result of which average measurement accuracy ΔEave is the minimum value may be displayed by highlighting such that a user can instantly notice the performed order number of the color adjusting operation that is appropriate. In addition to the adjustment results, a character string or an icon representing the repeat state may be displayed by highlighting.

In the above-described embodiments, operating the OK button 875 in the color adjusting wizard screen image 800 causes the color adjusting wizard screen image 800 to be closed, and causes a transition to the confirmation screen image 700. However, in order to prevent operational error, the OK button 857 is displayed in a state of gray out until an appropriate result is obtained such that transition to the confirmation screen image 700 is prohibited.

Further, in the example in the above-described embodiments, a user takes the color measuring device 150 with his or her hand to measure colors of the color chart. However, it is not limited to this, and the color measuring device 150 may be installed at the printer 300 so that the printer 300 automatically performs color measurement at the time of discharging a printed material of the color chart.

In the example in the above-described embodiments, the color conversion table is adjusted (modified). However, it is not limited to this, and any different method that can adjust input-output relation of the color converting process may be adopted.

The configuration of the printing system 1 is described above as the main configuration for describing the feature of each embodiment, and is not limited to the above-described configuration. The configuration of the printing system 1 does not exclude configurations provided in general client device 100, printer controller 200, and printer 300.

Each functional configuration of the above-described printing system 1 is a configuration classified in accordance with main process contents, to facilitate understanding of each functional configuration. A manner of classifying the configuration elements, and the names of the configuration elements do not limit the present invention. Each functional configuration can be classified into more configuration elements. Classification can be made such that one configuration element performs more process contents.

The programs that cause the client device 100, the printer controller 200, and the printer 300 to operate may be provided by non-transitory computer readable recording medium such as a USB memory, a floppy (registered trademark in Japan) disk, and a CD-ROM, or may be provided online via a network such as the Internet. In this case, the programs recorded in the non-transitory computer readable recording medium are usually forwarded to ROMs or HDDs to be stored therein. The programs may be provided as single application software, or may be incorporated into software of the corresponding device, as one function of the client device 100, the printer controller 20, or the printer 300.

The process of each of the above-described configuration element can be embodied also by a dedicated hardware circuit. In this case, the process may be performed by one piece of hardware, or plural pieces of hardware.

As described above, according to the above-described embodiments or modified examples, when adjustment concerning color conversion is performed plural times, the adjustment result together with the repeat state of the adjustment are displayed each time the adjustment is performed. Thereby, a user can easily recognize effectiveness of the respective adjustment by seeing the adjustment results displayed for each adjustment. A user can easily select the optimum adjustment result from a plurality of the displayed adjustment results, and register the adjustment contents at that time. Further, a user can recognize adjustment progress state such as the performed order number of the currently performed adjustment by seeing the repeat state of the color adjusting operation. By comprehensively seeing the displayed adjustment results and repeat state, a user can appropriately determine whether or not the additional adjustment concerning color conversion should be performed, and can appropriately determine how to perform adjustment when the additional adjustment is performed. Thus, the present invention can provide a user with sufficient information for making color conversion adjusting operation more efficient.

What is claimed is:

1. A non-transitory computer readable recording medium stored with a color adjustment instructing program, said program causing a computer to execute a process comprising the steps of:
(a) instructing a color chart to be printed, the color chart being formed by a plurality of color patches expressed by different color data;
(b) obtaining a color measurement result of a printed material that is produced by printing in response to the instructing;
(c) calculating an adjustment result in a case where adjustment of a conversion table of a color space is performed on the basis of the color measurement result; and
(d) displaying the adjustment result calculated for each adjustment and a repeat state of the adjustment, when the adjustment is repeatedly performed.

2. The non-transitory computer readable recording medium as claimed in claim 1, wherein
said step (d) includes concurrently displaying, in a predetermined main window, a button for instructing the color chart to be printed, a list of the color measurement results, the adjustment results and the repeat state, a button for causing a transition to a screen image for re-calculating the adjustment result, and a button for causing a transition to a screen image for newly calculating an adjustment result.

3. The non-transitory computer readable recording medium as claimed in claim 2, said program causing the computer to further execute the steps of:
(e) giving an instruction to start displaying the main window; and
(f) selectively registering a part of the adjustment results from a plurality of the adjustment results,
wherein said step (d) includes concurrently displaying, in an initial window different from the main window, an opening button for giving an instruction to start displaying the main window, and a box for instructing the registering.

4. The non-transitory computer readable recording medium as claimed in claim 3, wherein
said step (d) includes displaying contents of a calculation process to be performed in a sub-window, before performing the process of calculating the adjustment result, and
in the sub-window, a button for causing a transition to the initial window, and a button for causing a transition to the main window are provided.

5. The non-transitory computer readable recording medium as claimed in claim 1, wherein
the adjustment result includes information of accuracy concerning conversion of the color space.

6. The non-transitory computer readable recording medium as claimed in claim 5, wherein
said step (d) includes displaying the accuracy within a predetermined range, by highlighting.

7. The non-transitory computer readable recording medium as claimed in claim 5, wherein
said step (d) includes displaying the accuracy that is a minimum value, by highlighting.

8. A color adjustment instructing device comprising:
a chart print instructing unit for instructing a color chart to be printed, the color chart being formed by a plurality of color patches expressed by different color data;
a color measuring unit for obtaining a color measurement result of a printed material that is produced by printing in response to the instructing;
a result calculating unit for calculating an adjustment result in a case where adjustment of a conversion table of a color space is performed on the basis of the color measurement result; and
a displaying unit for displaying the adjustment result calculated for each adjustment and a repeat state of the adjustment, when the adjustment is repeatedly performed.

9. The color adjustment instructing device as claimed in claim 8, wherein
The displaying unit concurrently displays, in a predetermined main window, a button for instructing the color chart to be printed, a list of the color measurement results, the adjustment results and the repeat state, a button for causing a transition to a screen image for re-calculating the adjustment result, and a button for causing a transition to a screen image for newly calculating an adjustment result.

10. The color adjustment instructing device as claimed in claim 9, further comprising:
a start instructing unit for giving an instruction to start displaying the main window; and
a registering unit for selectively registering a part of the adjustment results from a plurality of the adjustment results,
wherein the displaying unit concurrently displays, in an initial window different from the main window, an opening button for giving an instruction to start displaying, and a box for instructing the registering.

11. The color adjustment instructing device as claimed in claim 10, wherein
the displaying unit displays contents of a calculation process to be performed in a sub-window, before performing the process of calculating the adjustment result, and
in the sub-window, a button for causing a transition to the initial window, and a button for causing a transition to the main window are provided.

12. The color adjustment instructing device as claimed in claim 8, wherein
the adjustment result includes information of accuracy concerning conversion of the color space.

13. The color adjustment instructing device as claimed in claim 12, wherein
the displaying unit displays the accuracy within a predetermined range, by highlighting.

14. The color adjustment instructing device as claimed in claim 12, wherein
the displaying unit displays the accuracy that is a minimum value, by highlighting.
